(19) United States
(12) Patent Application Publication
(10) Pub. No.: US 2026/0001493 A1
(43) Pub. Date: Jan. 1, 2026

(54) HITCH RECEIVER MOUNTING DEVICE

(71) Applicant: Junior Person, Prince George, VA (US)

(72) Inventor: Junior Person, Prince George, VA (US)

(21) Appl. No.: 18/756,397

(22) Filed: Jun. 27, 2024

(51) Int. Cl. B60R 9/08; A63B 55/60; B60R 9/06

(52) U.S. Cl. CPC B60R 9/08; B60R 9/06; A63B 55/61

(57) ABSTRACT

A hitch receiver mounting device for mounting a hitch receiver to a golf cart includes a golf cart that has a frame. A pair of mounting brackets is included which has a pair of first attachment elements and a pair of second attachment elements. Each of the first attachment elements on each of the pair of mounting brackets is attachable the frame of the golf cart. A hitch receiver is attachable to the plurality of second attachment elements in each of the pair of mounting brackets thereby retaining the hitch receiver on the frame of the golf cart.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hitch receiver devices and more particularly pertains to a new hitch receiver device for mounting a hitch receiver to a golf cart. The device includes a pair of mounting brackets that are each attachable to a frame of a golf cart at a point located near a rear end of the golf cart. The device includes a hitch receiver that has a plurality of mounting tabs which each receive a fastener that attaches to the mounting brackets to secure the hitch receiver to the mounting brackets.

### (2) Description of Related Art Including Information Disclosed Under 37 CFR 1.97 and 1.98

The prior art relates to hitch receiver devices including a variety of hitch receiver devices that are structured to be attached to a bumper of a pickup truck and a hitch receiver device that includes a panel and a pair of strategically shaped members to attach the panel to a rear end of a body of a golf cart to accommodate a tow hitch. In no instance does the prior art disclose a hitch receiver device that includes a pair of L-shaped mounting brackets that are each attachable to a frame of a golf cart and a hitch receiver which has a plurality of mounting tabs that receive a fastener for attaching the hitch receiver to the pair of mounting brackets.

### BRIEF SUMMARY OF THE INVENTION

An embodiment of the disclosure meets the needs presented above by generally comprising a golf cart that has a frame. A pair of mounting brackets is included which has a pair of first attachment elements and a pair of second attachment elements. Each of the first attachment elements on each of the pair of mounting brackets is attachable the frame of the golf cart. A hitch receiver is attachable to the plurality of second attachment elements in each of the pair of mounting brackets thereby retaining the hitch receiver on the frame of the golf cart.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a hitch receiver mounting device according to an embodiment of the disclosure.

FIG. 2 is a front view of a mounting bracket of an embodiment of the disclosure.

FIG. 3 is a left side view of a pair of mounting brackets of an embodiment of the disclosure.

FIG. 4 is a top view of a pair of mounting brackets of an embodiment of the disclosure.

FIG. 5 is a bottom in-use view of an embodiment of the disclosure.

FIG. 6 is an top perspective view of a pair of mounting brackets of an embodiment of the disclosure.

FIG. 7 is a perspective in-use view of an embodiment of the disclosure showing a towing hitch being inserted into a hitch receiver.

### DETAILED DESCRIPTION OF THE INVENTION

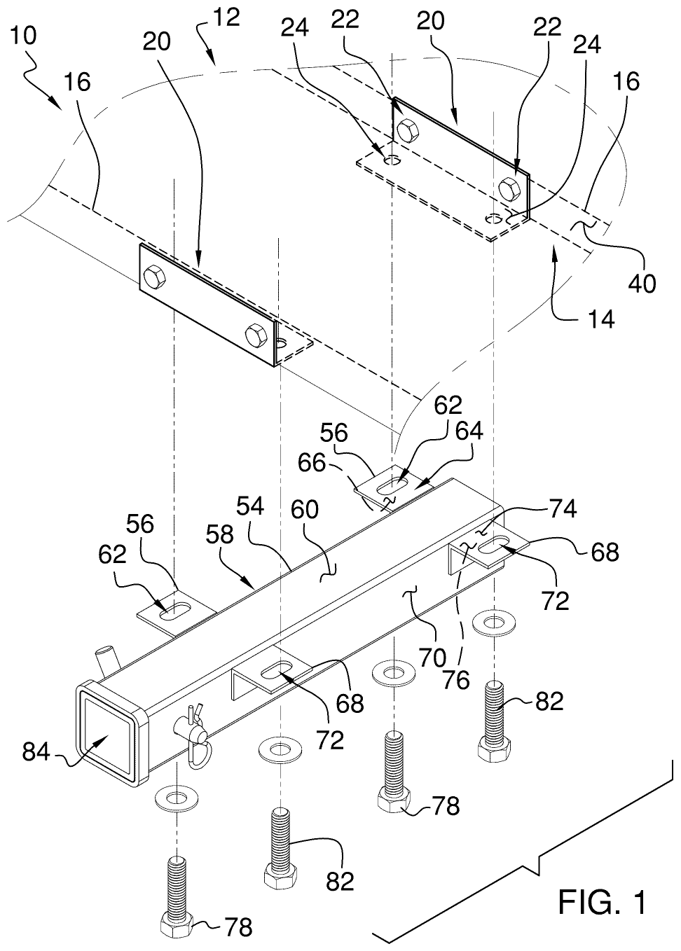

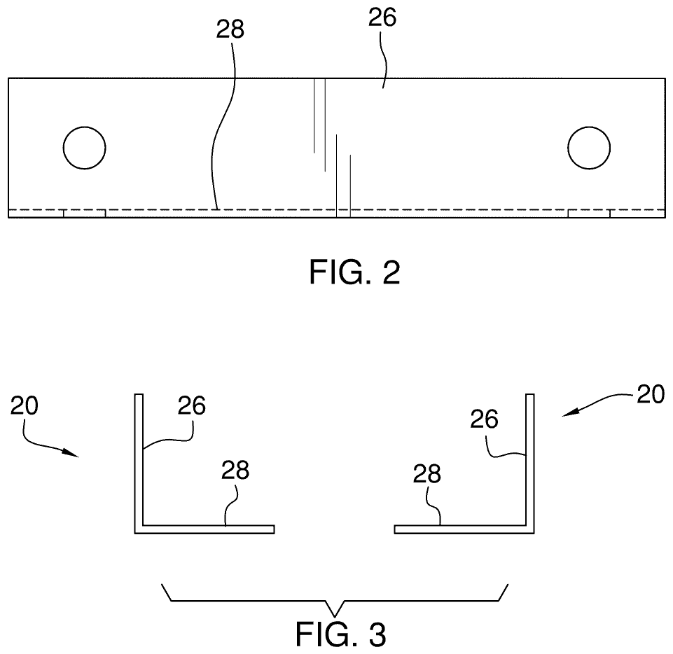

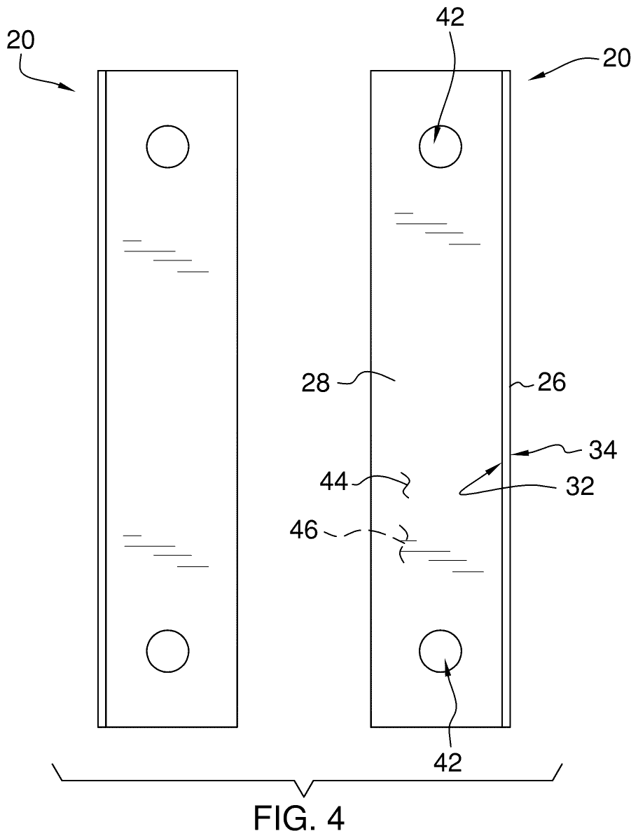

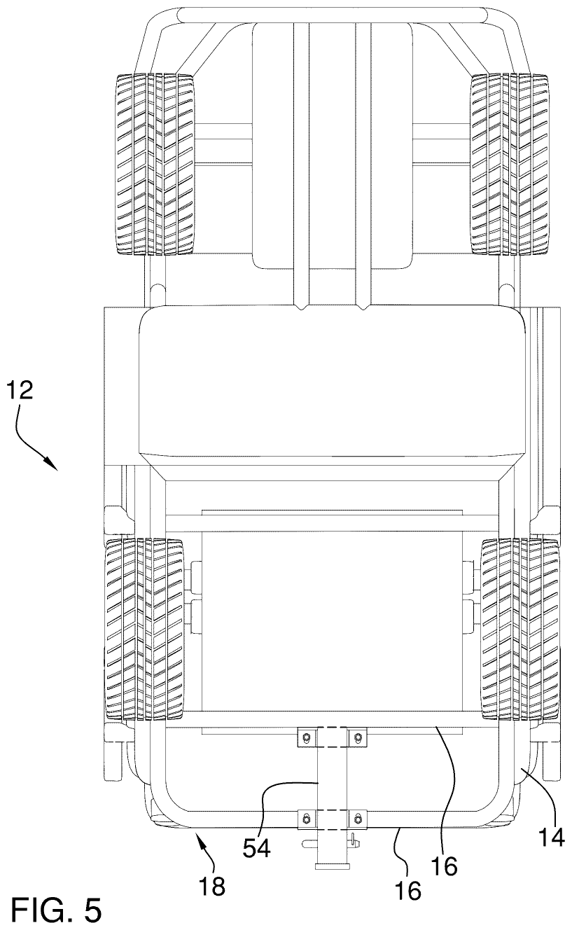

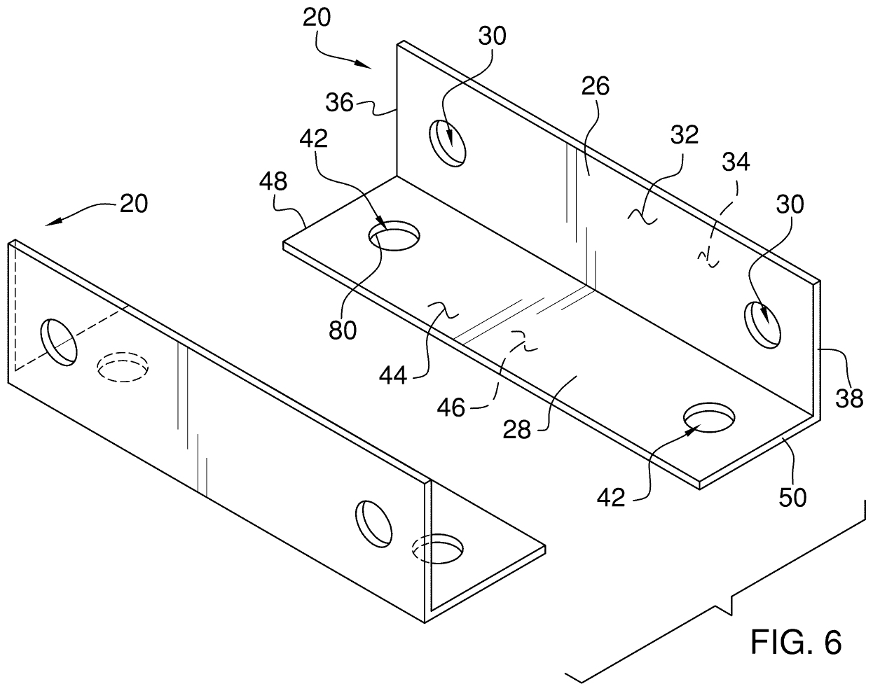

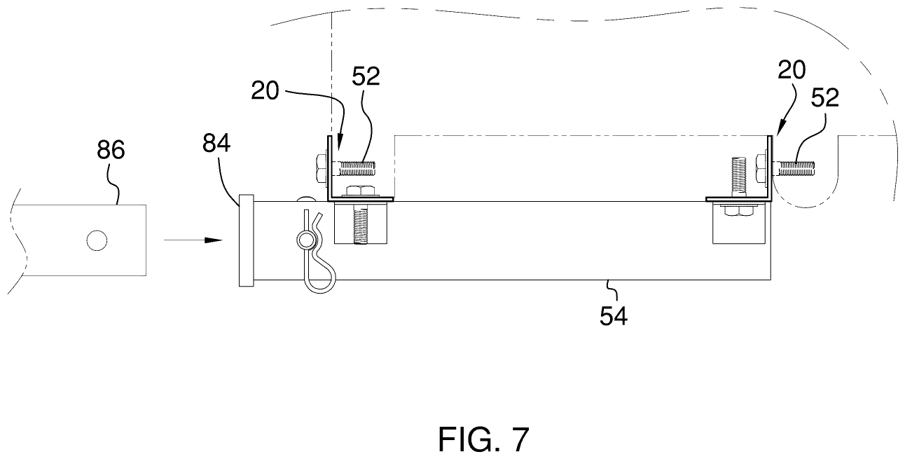

With reference now to the drawings, and in particular to FIGS. 1 through 7 thereof, a new hitch receiver device embodying the principles and concepts of an embodiment of the disclosure and generally designated by the reference numeral 10 will be described.

As best illustrated in FIGS. 1 through 7, the hitch receiver mounting device 10 generally comprises a golf cart 12 that has a frame 14 and the frame 14 includes a pair of lateral members 16 which are spaced apart from each other and oriented parallel to each other. Additionally, each of the pair of lateral members 16 is located proximate a rear end 18 of the golf cart 12. The golf cart 12 may be an electric golf cart, a gas powered golf cart or any other type of golf cart that is commonly driven on either municipal or private golf courses.

A pair of mounting brackets 20 is provided and each of the pair of mounting brackets 20 has a pair of first attachment elements 22 and a pair of second attachment elements 24. Each of the pair of first attachment elements 22 on a respective one of the pair of mounting brackets 20 lies on a plane that is oriented perpendicular to each of the second attachment elements 24 on the respective mounting bracket 20. Additionally, each of the first attachment elements 22 on each of the pair of mounting brackets 20 is attachable to a respective one of the pair of lateral members 16 of the frame 14 of the golf cart 12. Each of the pair of mounting brackets 20 comprises a first panel 26 which is perpendicularly oriented with a second panel 28 such that each of the pair of mounting brackets 20 has an L shape. Furthermore, each of the pair of mounting brackets 20 may be comprised of a rigid material, including but not being limited to, steel or aluminum or a metal alloy.

Each of the pair of mounting brackets 20 has a pair of first holes 30 each extending through a front surface 32 and a back surface 34 of the first panel 26. Each of the pair of first holes 30 in the first panel 26 of a respective mounting bracket 20 is spaced apart from each other and is positioned on a line which extends between a first end 36 and a second end 38 of the first panel 26 of the respective mounting bracket 20. The first panel 26 of each of the pair of mounting brackets 20 lies against a lateral surface 40 of a respective one of the pair of lateral members 16 of the frame 14 of the golf cart 12 such that the second panel 28 of each of the pair of mounting brackets 20 lies on a horizontal plane.

Each of the pair of mounting brackets 20 has a pair of second holes 42 each extending through a top surface 44 and a bottom surface 46 of the second panel 28. Each of the pair of second holes 42 in the second panel 28 of a respective mounting bracket 20 is spaced apart from each other and is positioned on a line which extends between a first end 48 and a second end 50 of the second panel 28 of the respective mounting bracket 20. Additionally, each of the pair of first holes 30 in the first panel 26 of a respective one of the pair of mounting brackets 20 is aligned with a respective one of the pair of second holes 42 in the second panel 28 of the respective mounting bracket 20.

A plurality of first fasteners 52 is provided and each of the plurality of first fasteners 52 is extendable through a respective one of the pair of first holes 30 in the first panel 26 of a respective one of the pair of mounting brackets 20 to engage the lateral surface 40 of the lateral member 16 on which the respective mounting bracket 20 is positioned. Furthermore, each of the plurality of first fasteners 52 and each of the pair of first holes 30 in the first panel 26 of each of the pair of mounting brackets 20 defines a respective one of the first attachment elements 22 of a respective mounting bracket 20. Each of the plurality of first fasteners 52 may comprise a bolt or other type of threaded fastener and each of the first fasteners 52 threadably engages the lateral surface 40 of the lateral member 16 on which the respective mounting bracket 20 is positioned.

A hitch receiver 54 is attachable to the plurality of second attachment elements 24 in each of the pair of mounting brackets 20 thereby retaining the hitch receiver 54 on the frame 14 of the golf cart 12. The hitch receiver 54 has a pair of first mounting tabs 56 each extending laterally away from a first lateral surface 58 of the hitch receiver 54 at a point which is aligned with a top surface 60 of the hitch receiver 54. Additionally, each of the pair of first mounting tabs 56 has a primary hole 62 extending through an upper surface 64 and a lower surface 66 of the first mounting tabs 56. The first mounting tabs 56 are spaced apart from each other and are distributed along a substantial length of the first lateral surface 58 of the hitch receiver 54.

The hitch receiver 54 has a pair of second mounting tabs 68 each extending laterally away from a second lateral surface 70 of the hitch receiver 54 at a point which is aligned with the top surface 60 of the hitch receiver 54. Each of the pair of second mounting tabs 68 has a secondary hole 72 extending through an upper surface 74 and a lower surface 76 of the second mounting tabs 68. Additionally, each of the pair of second mounting tabs 68 is aligned with a respective one of the pair of first mounting tabs 56. The hitch receiver 54 is oriented to extend between the pair of mounting brackets 20 having the top surface 60 of the hitch receiver 54 abutting the bottom surface 46 of the second panel 28 of each of the pair of mounting brackets 20. The primary hole 62 each of the pair of first mounting tabs 56 is aligned with a respective one of the pair of second holes 42 in the second panel 28 of each of the pair of mounting brackets 20. Additionally, the secondary hole 72 in each of the pair of second mounting tabs 68 is aligned with a respective one of the pair of second holes 42 in the second panel 28 of each of the pair of mounting brackets 20.

A pair of second fasteners 78 is each extendable through the primary hole 62 in a respective one of the pair of first mounting tabs 56 and a respective one of the pair of second holes 42 in the second panel 28 of a respective one of the mounting brackets 20. Furthermore, each of the pair of second fasteners 78 and the respective second holes 42 defines a respective one of the second attachment elements 24 of a respective one of the mounting brackets 20. Each of the plurality of second fasteners 78 may comprise a bolt or other type of threaded fastener. Additionally, each of the second fasteners 78 threadably engages a bounding edge 80 of the respective second hole 42.

A pair of third fasteners 82 is each extendable through the secondary hole 72 in a respective one of the pair of second mounting tabs 68 and a respective one of the pair of second holes 42 in the second panel 28 of a respective one of the mounting brackets 20. Furthermore, each of the pair of third fasteners 82 and the respective second holes 42 defines a respective one of the second attachment elements 24 of a respective one of the mounting brackets 20. Additionally, each of the third fasteners 82 may comprise a bolt or other type of threaded fastener and each of the third fasteners 82 threadably engages the bounding edge 80 of the respective second holes 42. The hitch receiver 54 extends beyond the rear end 18 of the golf cart 12 thereby enabling an open end 84 of the hitch receiver 54 to insertably receive a towing hitch 86 for mounting the towing hitch 86 to the golf cart 12. Additionally, a step may be inserted into the open end 84 of the hitch receiver 54 to assist a physically limited user to climb into the golf cart 12.

In use, the first fasteners 52 are employed to mount the first panel 26 of each of the pair of mounting brackets 20 to the respective lateral member 16 of the frame 14 of the golf cart 12 at a location near the rear end 18 of the golf cart 12. The hitch receiver 54 is placed against the second panel 28 of each of the pair of mounting brackets 20 to align the first mounting tabs 56 and the second mounting tabs 68 with the respective second hole 42 in the pair of mounting brackets 20. The second fasteners 78 and the third fasteners 82 are employed to mount the hitch receiver 54 to the pair of mounting brackets 20. In this way the hitch receiver 54 can be securely mounted to the golf cart 12 to enable to hitch receiver 54 to support a substantial load without damaging the golf cart 12. Thus, a step, for example, could be mounted to the hitch receiver 54 to enable a physically limited person to climb onto the golf cart 12 or a towing hitch could 86 be mounted to the hitch receiver 54 to enable the golf cart 12 to be employed for towing.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hitch receiver mounting device for mounting a hitch receiver to a golf cart, said device comprising:
a golf cart having a frame;
a pair of mounting brackets, each of said pair of mounting brackets having a pair of first attachment elements and a pair of second attachment elements, each of said pair of first attachment elements on a respective one of said pair of mounting brackets lying on a plane being oriented perpendicular to each of said second attachment elements on said respective mounting bracket, each of said first attachment elements on each of said pair of mounting brackets being attachable to a respective one of said pair of lateral members of said frame of said golf cart; and
a hitch receiver being attachable to said plurality of second attachment elements in each of said pair of mounting brackets thereby retaining said hitch receiver on said frame of said golf cart.

2. The device according to claim 1, wherein:
said frame includes a pair of lateral members which are spaced apart from each other and oriented parallel to each other;
each of said pair of lateral members is located proximate a rear end of said golf cart;
each of said pair of mounting brackets comprises a first panel being perpendicularly oriented with a second panel such that each of said pair of mounting brackets has an L shape;
each of said pair of mounting brackets has a pair of first holes each extending through a front surface and a back surface of said first panel;
each of said pair of first holes in said first panel of a respective mounting bracket is spaced apart from each other and is positioned on a line which extends between a first end and a second end of said first panel of said respective mounting bracket;
said first panel of each of said pair of mounting brackets lies against a lateral surface of a respective one of said pair of lateral members of said frame of said golf cart such that said second panel of each of said pair of mounting brackets lies on a horizontal plane;
each of said pair of mounting brackets has a pair of second holes each extending through a top surface and a bottom surface of said second panel;
each of said pair of second holes in said second panel of a respective mounting bracket is spaced apart from each other and is positioned on a line which extends between a first end and a second end of said second panel of said respective mounting bracket; and
each of said pair of first holes in said first panel of a respective one of said pair of mounting brackets is aligned with a respective one of said pair of second holes in said second panel of said respective mounting bracket.

3. The device according to claim 2, wherein:
said device includes a plurality of first fasteners; and
each of said plurality of first fasteners is extendable through a respective one of said pair of first holes in said first panel of a respective one of said pair of mounting brackets to engage said lateral surface of said lateral member on which said respective mounting bracket is positioned such that each of said plurality of first fasteners and each of said pair of first holes in said first panel of each of said pair of mounting brackets defines a respective one of said first attachment elements of a respective mounting bracket.

4. The device according to claim 2, wherein:
said hitch receiver has a pair of first mounting tabs each extending laterally away from a first lateral surface of said hitch receiver at a point being aligned with a top surface of said hitch receiver;
each of said pair of first mounting tabs has a primary hole extending through an upper surface and a lower surface of said first mounting tabs;
said pair of first mounting tabs is spaced apart from each other and is distributed along a substantial length of said first lateral surface of said hitch receiver;
said hitch receiver has a pair of second mounting tabs each extending laterally away from a second lateral surface of said hitch receiver at a point being aligned with said top surface of said hitch receiver;
each of said pair of second mounting tabs has a secondary hole extending through an upper surface and a lower surface of said second mounting tabs;
each of said pair of second mounting tabs is aligned with a respective one of said pair of first mounting tabs; and
said hitch receiver is oriented to extend between said pair of mounting brackets having said top surface of said hitch receiver abutting said bottom surface of said second panel of each of said pair of mounting brackets.

5. The device according to claim 4, wherein:
said primary hole each of said pair of first mounting tabs is aligned with a respective one of said pair of second holes in said second panel of each of said pair of mounting brackets;
said device includes a pair of second fasteners; and
each of said pair of second fasteners is extendable through a said primary hole in a respective one of said pair of first mounting tabs and a respective one of said pair of second holes in said second panel of a respective one of said mounting brackets such that each of said pair of second fasteners and said respective second holes defines a respective one of said second attachment elements of a respective one of said mounting brackets.

6. The device according to claim 4, wherein:
said secondary hole in each of said pair of second mounting tabs is aligned with a respective one of said pair of second holes in said second panel of each of said pair of mounting brackets;
said device includes a pair of second fasteners;
said device includes a pair of third fasteners;
each of said pair of third fasteners is extendable through said secondary hole in a respective one of said pair of second mounting tabs and a respective one of said pair of second holes in said second panel of a respective one of said mounting brackets such that each of said pair of third fasteners and said respective second holes defines a respective one of said second attachment elements of a respective one of said mounting brackets.

7. The device according to claim 1, wherein said hitch receiver extends beyond a rear end of said golf cart thereby enabling an open end of said hitch receiver to insertably receive a hitch for mounting said hitch to said golf cart.

8. A hitch receiver mounting device for mounting a hitch receiver to a golf cart, said device comprising:
a golf cart having a frame, said frame including a pair of lateral members which are spaced apart from each other and oriented parallel to each other, each of said pair of lateral members being located proximate a rear end of said golf cart;
a pair of mounting brackets, each of said pair of mounting brackets having a pair of first attachment elements and a pair of second attachment elements, each of said pair of first attachment elements on a respective one of said pair of mounting brackets lying on a plane being oriented perpendicular to each of said second attachment elements on said respective mounting bracket, each of said first attachment elements on each of said pair of mounting brackets being attachable to a respective one of said pair of lateral members of said frame of said golf cart, each of said pair of mounting brackets comprising a first panel being perpendicularly oriented with a second panel such that each of said pair of mounting brackets has an L shape, each of said pair of mounting brackets having a pair of first holes each extending through a front surface and a back surface of said first panel, each of said pair of first holes in said first panel of a respective mounting bracket being spaced apart from each other and being positioned on a line which extends between a first end and a second end of said first panel of said respective mounting bracket, said first panel of each of said pair of mounting brackets lying against a lateral surface of a respective one of said pair of lateral members of said frame of said golf cart such that said second panel of each of said pair of mounting brackets lies on a horizontal plane, each of said pair of mounting brackets having a pair of second holes each extending through a top surface and a bottom surface of said second panel, each of said pair of second holes in said second panel of a respective mounting bracket being spaced apart from each other and being positioned on a line which extends between a first end and a second end of said second panel of said respective mounting bracket, each of said pair of first holes in said first panel of a respective one of said pair of mounting brackets being aligned with a respective one of said pair of second holes in said second panel of said respective mounting bracket;
a plurality of first fasteners, each of said plurality of first fasteners being extendable through a respective one of said pair of first holes in said first panel of a respective one of said pair of mounting brackets to engage said lateral surface of said lateral member on which said respective mounting bracket is positioned such that each of said plurality of first fasteners and each of said pair of first holes in said first panel of each of said pair of mounting brackets defines a respective one of said first attachment elements of a respective mounting bracket;
a hitch receiver being attachable to said plurality of second attachment elements in each of said pair of mounting brackets thereby retaining said hitch receiver on said frame of said golf cart, said hitch receiver having a pair of first mounting tabs each extending laterally away from a first lateral surface of said hitch receiver at a point being aligned with a top surface of said hitch receiver, each of said pair of first mounting tabs having a primary hole extending through an upper surface and a lower surface of said first mounting tabs, said pair of first mounting tabs being spaced apart from each other and being distributed along a substantial length of said first lateral surface of said hitch receiver, said hitch receiver having a pair of second mounting tabs each extending laterally away from a second lateral surface of said hitch receiver at a point being aligned with said top surface of said hitch receiver, each of said pair of second mounting tabs having a secondary hole extending through an upper surface and a lower surface of said second mounting tabs, each of said pair of second mounting tabs being aligned with a respective one of said pair of first mounting tabs, said hitch receiver being oriented to extend between said pair of mounting brackets having said top surface of said hitch receiver abutting said bottom surface of said second panel of each of said pair of mounting brackets, said primary hole each of said pair of first mounting tabs being aligned with a respective one of said pair of second holes in said second panel of each of said pair of mounting brackets, said secondary hole in each of said pair of second mounting tabs being aligned with a respective one of said pair of second holes in said second panel of each of said pair of mounting brackets;
a pair of second fasteners, each of said pair of second fasteners being extendable through a said primary hole in a respective one of said pair of first mounting tabs and a respective one of said pair of second holes in said second panel of a respective one of said mounting brackets such that each of said pair of second fasteners and said respective second holes defines a respective one of said second attachment elements of a respective one of said mounting brackets;
a pair of third fasteners, each of said pair of third fasteners being extendable through said secondary hole in a respective one of said pair of second mounting tabs and a respective one of said pair of second holes in said second panel of a respective one of said mounting brackets such that each of said pair of third fasteners and said respective second holes defines a respective one of said second attachment elements of a respective one of said mounting brackets; and
wherein said hitch receiver extends beyond said rear end of said golf cart thereby enabling an open end of said hitch receiver to insertably receive a hitch for mounting said hitch to said golf cart.
